(19) United States
(12) Patent Application Publication
(10) Pub. No.: US 2009/0320585 A1
(43) Pub. Date: Dec. 31, 2009

(54) Deployment Control System

(76) Inventor: David Cohen, Tel-Aviv (IL)

Correspondence Address: MARTIN D. MOYNIHAN d/b/a PRTSI, INC., P.O. BOX 16446, ARLINGTON, VA, 22215, US

(21) Appl. No.: 12/226,917

(22) PCT Filed: Apr. 10, 2007
(86) PCT No.: PCT/IL2007/000464

§ 371 Date: Oct. 31, 2008

Related U.S. Application Data
(60) Provisional application No. 60/852,653, filed on Oct. 19, 2006.

(30) Foreign Application Priority Data
Apr. 4, 2006 (IL) 174780
Apr. 30, 2006 (IL) 175329
May 16, 2006 (IL) 175682

(51) Int. Cl. G01L 5/14

(52) U.S. Cl. 73/167

(57) ABSTRACT

Deployment control system comprises a weapon usage monitoring system for obtaining data of weapon usage, an aggregation system for aggregating usage of individual weapons to a predetermined level, and a presentation system for presentation of said weapon usage individually or at the predetermined level.

### FIELD AND BACKGROUND OF THE INVENTION

The present invention relates to a deployment control system and, more particularly, but not exclusively to an automatic system that provides real time information about the location and status of units out in the field.

Since ancient times a commander has had to rely on communication, either visual or verbal, with officers to find out how soldiers are complying with plans and what is happening on the field, in other words a verbal report, or there was direct line of sight. But line of sight is usually not sufficient for a battlefield, due to size, scattering of soldiers, physical obstacles etc. Once the force has begun moving into position they often retain cover so he can't see them in any event. Today they often use UAVs or mounted helmet cameras to obtain a view of what soldiers are doing.

But officers in field also rely on line of sight or verbal conformation and don't really know what their individual units are doing. Often battle fought at squad or platoon level and in small skirmishes and there is little chance that the commander will find out in real time what individual teams or even platoons are doing. Often a platoon commander can lose track of his squads after a series of skirmishes in which they spread over a terrain.

In order to retain control, modern forces rely on communication. However even communication is insufficient as in many cases forces that are to report what is happening in the pandemonium of a battle either cannot report or present an inaccurate report deriving from disorientation or a subjective perception of their performance.

As the army is built as a hierarchy, and as operations coincide with a large scale battleplan, it so happens that a commander at the brigade level may rely on the performance of a squad that is carrying out a specialist mission that is a lynchpin for the operation.

It is desirable to know when any kind of unit encounters emergency situations. In particular vehicles including those of the police, security staff and military vehicles can be the subject of attacks and other emergencies with which they are unable to cope. In such a case it is desirable for the subject of the attack to call for help, but sometimes the nature of the emergency renders calling for help impossible. Current systems are able to trace units at a low level of resolution, and there are systems which say where the soldier is.

In counter-insurgency there is much usage of roadside bombs and landmines and shoulder-mounted missiles, against small units that may be incapacitated. In particular, where the unit is a single vehicle, the unit may be unable to report following such an attack. It is often some time before the central command knows that anything has happened and in the meantime the soldiers may have been taken prisoner.

Also there is no way at the moment for a remotely based commander to automatically know the direction from which a unit has been attacked, or the nature of the attack or weapon used. This is irrespective of whether the unit is vehicle based.

There is thus a widely recognized need for, and it would be highly advantageous to have, a system that allows a commander real time control of his forces that is devoid of the above limitations.

### SUMMARY OF THE INVENTION

According to one aspect of the present invention there is provided a battlefield deployment system which gathers data from a weapon control system.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a weapon monitoring system according to a first preferred embodiment of the present invention.

FIG. 2 shows the use of triangulation from weapons being fired to give a commander the location of a target. Preferably the commander is able to touch his screen at the point of triangulation in order to obtain coordinates of the target.

FIGS. 3-29 illustrate a deployment control system using the weapon monitoring system of FIG. 1.

FIGS. 30-32 illustrate a system for deployment on a vehicle.

### DESCRIPTION OF THE PREFERRED EMBODIMENTS

The present embodiments comprise an apparatus and a method for deployment control for battlefields and battlefield training.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

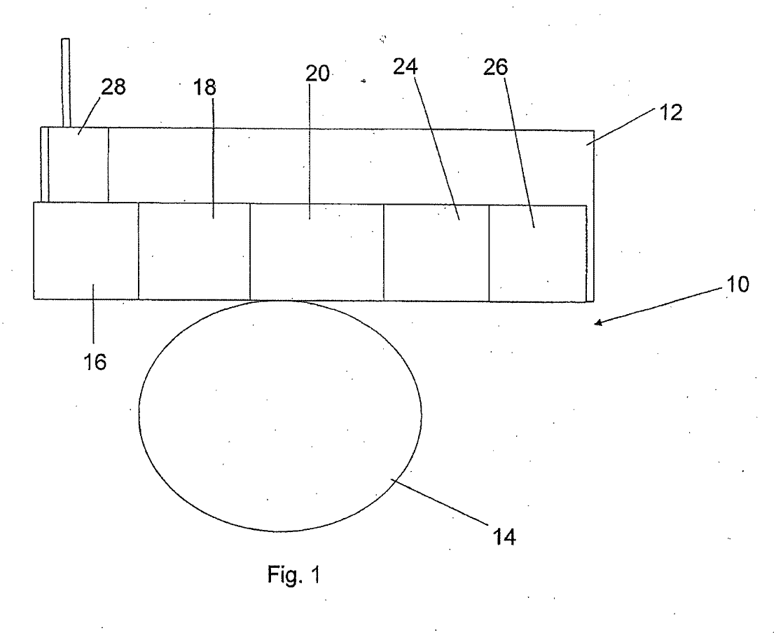

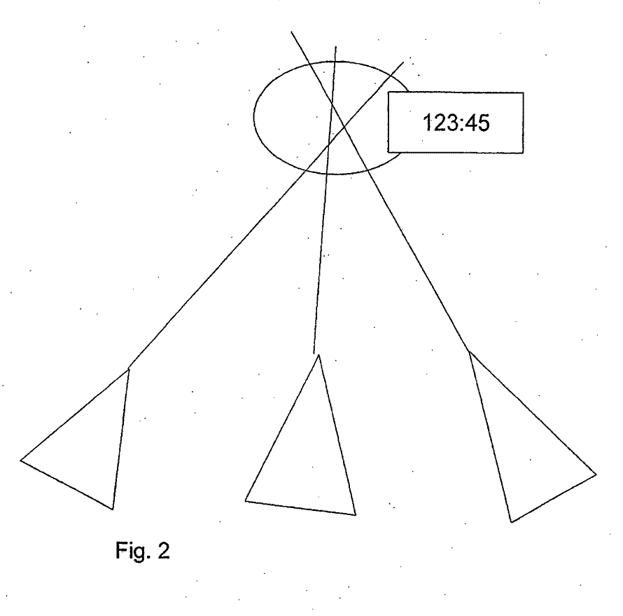

Reference is now made to FIG. 1, which illustrates a device 10 for monitoring weapon usage. The device comprises a usage monitoring unit 12 for electronically monitoring usage of the weapon, and a mounting unit 14 for mounting on the weapon. The device for monitoring weapon usage can be provided at infantry level and allows monitoring of units down to the level of the individual infantryman, as will be explained hereinbelow.

Preferably, the usage monitoring unit 12 comprises a firing detector 16 for detecting firing of the weapon. Firing detection may be based on detecting vibrations on the barrel of the weapon using an accelerometer, or alternatively may be based on detecting heat or change in a magnetic field, say at the mouth of the barrel.

Preferably, the usage monitoring unit comprises a status monitoring unit 18 configured to detect whether the weapon is primed. The status monitoring unit may involve a detector to detect whether a round is in the barrel and/or the safety catch is off.

The usage monitoring unit may further comprise an orientation detection unit 20, such as an electronic compass to detect the current azimuth or orientation of the weapon.

In one embodiment, the usage monitoring unit works with the status monitoring unit and only produces an output that detects a current orientation of the weapon when the weapon is primed.

The usage monitoring unit may additionally comprise an elevation detector 24 to detect the current elevation of the weapon. The orientation detection unit 20 together with the elevation unit serve to provide a clear indication of how the weapon is being aimed. In addition to orientation and elevation a further detector 26, such as a GPS detector may be used to determine the current location of the weapon.

A transmitter 28 is preferably provided for transmitting usage data to a remote location. The transmitter would typically use frequency hopping or other ways of secure transmission. The remote location receives information regarding location, orientation and elevation and is thus able to compute where the weapon is being aimed. The system as a whole can thus be used to keep track of weapon usage activity say with units of infantry.

The device may also include a directional beacon to transmit a directional beam aligned with the firing axis of the weapon. The directional beam may be intended to represent firing of the weapon in a training context or alternatively may provide a warning to friendly forces that the weapon is being trained on them.

The firing detector may operate to count the number of rounds fired and may provide an indication that further ammunition is required.

In the training or wargame context the directional beacon allows the target to know that he has been targeted while at the same time the transmitter can inform the umpire or marshal of what is going on.

In battle, enough data is provided to calculate an expected hit zone using ballistics information for each soldier. The ballistic paths and hit zones from the different soldiers can then be combined at the controller to determine the locations of targets. The hit zone can be shown visually on the controller. As an alternative to ballistic paths, a soldier can use his laser range finder, whose range data can be combined with the direction from the compass and the GPS data giving his location, to give a location of a target. The target location can be provided to the controller who may use the information as desired.

As explained, the basic device comprises a firing detector, GPS mechanism, compass and tilt mechanism, and a transmitter, of which at least the firing detector, compass and tilt mechanism are preferably mounted directly on the weapon. Firing the barrel leads to an electromagnetic charge which can be detected. An accelerometer can provide motion information of the infantryman. The device produces signals that indicate, location direction and elevation, allowing a map on an officer's PDA device to detect the signals and see exactly what the infantryman or tank etc is doing. The device can be interrogated actively or passively as desired.

The controlling officer has a computing and display device, which may be part of a hand held or laptop computer or may be incorporated into a vision device. The display may locate the weapon on a map and use an arrow to indicate the direction in which it is being aimed. The operator, typically the commanding officer, may view individual soldiers or groups of soldiers by name or by call sign.

The system may be active—it sends a request for data, or semi-active, in which it automatically sends for updates every five minutes or any other desired time delay or it may be passive, simply receiving signals when they are sent.

Now the soldier can use his laser ranging device in conjunction with a GPS signal and a compass to pass on to his commander the exact location of a target.

The display device may typically use the tip of an arrow to show where a soldier is aiming.

The officer's device may be incorporated into a hand held vision device. A lens may call up a map onto which a soldier's positions is superimposed.

The overall result is that an office can know what a soldier or group of soldiers is doing through their weapons.

In an embodiment, the soldiers are identified using an identity string. The string may be structured according to the hierarchy within the force and may group together soldiers belonging to the same unit to appear as a single symbol on the map. The unit level may be selected for convenience, or an individual officer may be shown only to a certain level, or only certain units.

The map shows the relationships between units and may make clear say if a particular unit is firing on a friendly unit.

The system shows units based on signals from individuals, and consequently provides unit symbols which have a meaning that has not been heretofore possible. The commander therefore has a higher level of control over his forces on the battlefield. He is able to see whether individual solders or the units that they comprise are complying with their tasks or not.

The devices are generally associated with the weapons so as to determine the compliance of the soldier with orders or to distinguish actual battlefield engagement from mere maneuver.

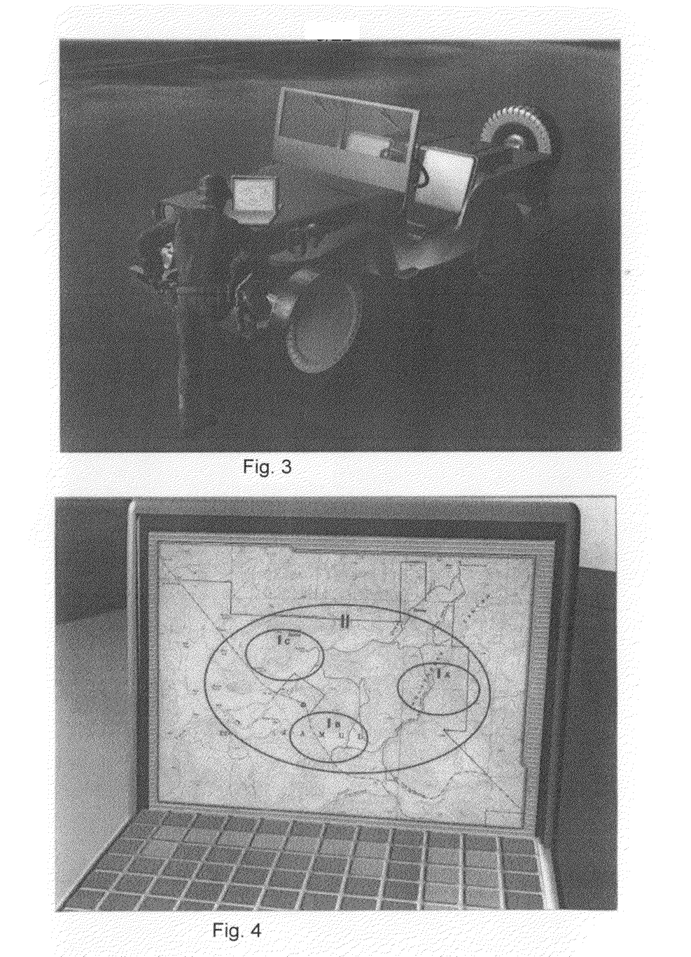

Reference is now made to FIG. 3, which is a simplified diagram showing an officer using the system for controlling a force. The system is here shown mounted on a laptop computer although it could alternatively be mounted on a handheld device such as Personal Digital Assistant, or any other kind of computing device.

The screen shows a map of the deployment area. Typically the map is a terrain map although other forms of display may be used. The display allows units to be shown in a hierarchy so that the commander can look at his forces at theater level, corps or division level, brigade or regiment level, or on the level of the battalion, company, platoon, squad or team or at the level of the individual soldier. By clicking on each individual unit it is possible to reach the next unit in the hierarchy. The next level in the hierarchy can then be shown in its entirety or individual units can be selected, as will be explained in greater detail below. As the view moves from one unit to the next in the hierarchy the map preferably zooms to show the unit in detail.

The user can choose the location and zoom level for the desired map. The user can for example use a touch screen to select a location and zoom to find his forces. It is possible to touch a point and choose a zoom from a list, or it may be possible to define the rectangle on a high level map that he wishes to view, and then a window is opened to show him the new view. This can be done by drawing a square or choosing corners.

Alternatively the user can enter exact or approximate coordinates, and then choose a zoom level.

As a further possibility the user can enter two or more coordinates in order to obtain corners of a viewing area.

As a further possibility the user may ask for a particular soldier, officer or location, such as a target location. As long as the soldier etc is recognized by the system the map will go to the appropriate location.

Reference is now made to FIG. 4, which is a screen shot illustrating a unit deployed over the map. The overall unit has a major unit marked II—a general sign for a batallion, which itself has three subunits I—platoons, designated A, B and C.

Plans may be made directly on the map. Drawing features can be used to insert movement axes and times. The map can be dynamically updated in real time with update reports from the monitoring devices on the individual soldiers. As mentioned, updating of the force units can be carried out by initiation from the commander's computer or the individual devices can send updates at regular intervals. Enemy units can be updated as their positions become apparent to the unit's intelligence. The soldier thus becomes an intelligence gathering device, who can pass on information that is meaningful further up the hierarchy but whose importance would be less apparent at the level of the individual soldier.

The maps shown can be defined by the units requested or by the mission that is to be carried out. The same map is shown enlarged in FIG. 4A

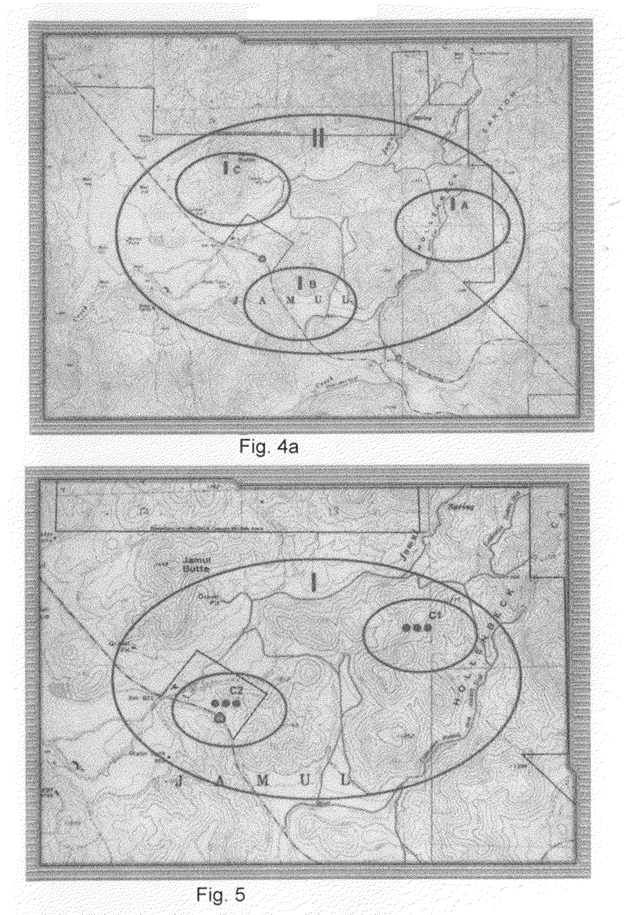

Reference is now made to FIG. 5, which illustrates the next level and shows the deployment of one of the sub-forces from FIG. 4. The sub force itself consists of two units C1 and C2. The three dots in each case show that the forces are at company level.

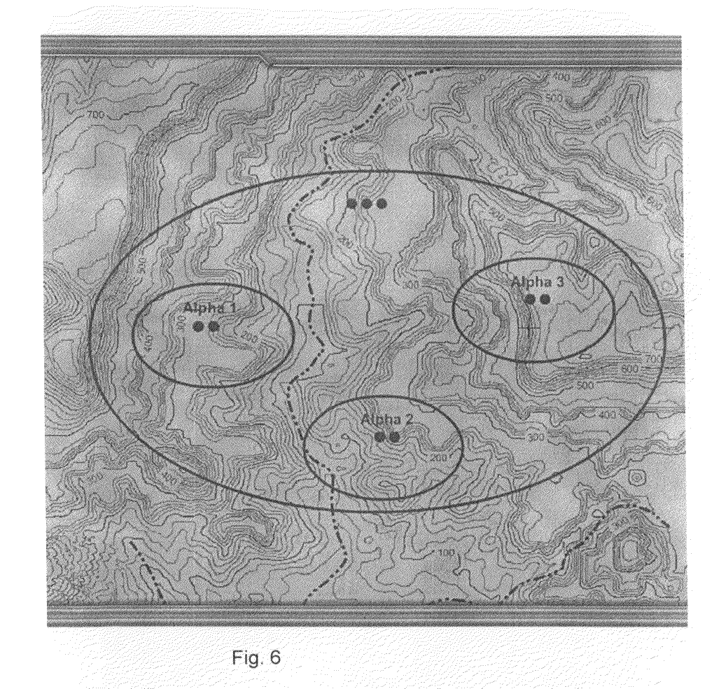

Reference is now made to FIG. 6 which shows the one of the companies at team level. The zoom-in process can continue to the level of individual soldiers as will be explained hereinbelow. The zoom in process can be based on selecting icons through the unit hierarchy or it can be based on choosing lower level units from a list of the constituent parts of the current unit. As a further alternative a combination of the above levels may be used, as convenient for the user.

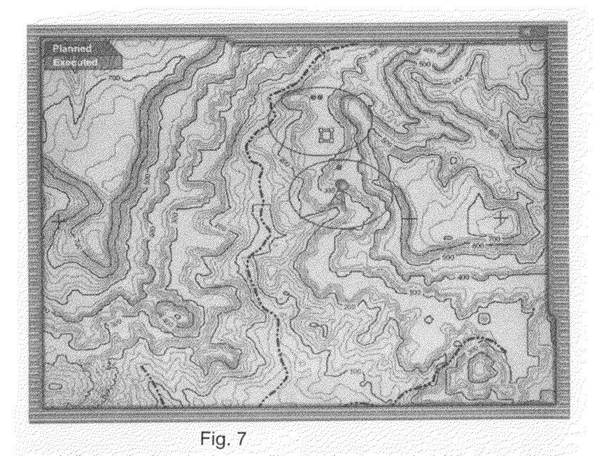

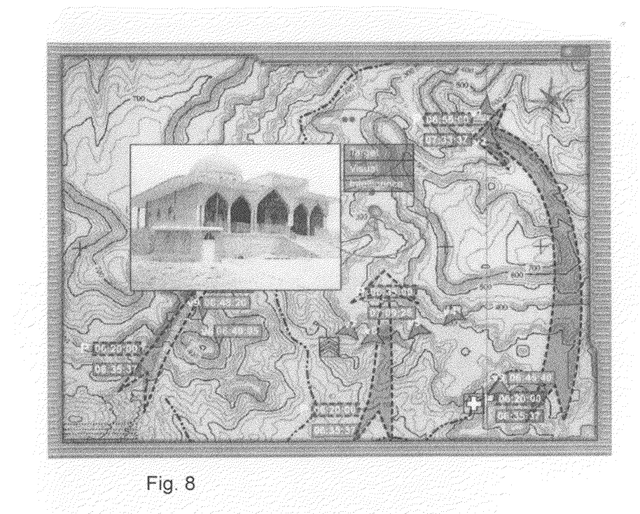

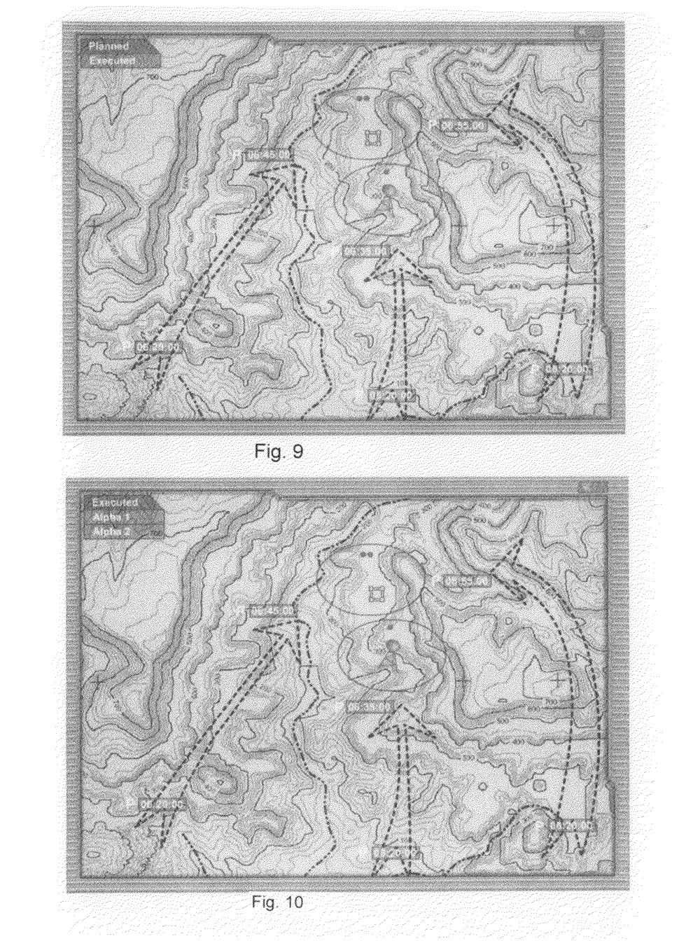

Reference is now made to FIG. 7, which is a simplified screen shot showing a contour map and illustrating two enemy units deployed thereon. One of the units is at team strength and one of the units is at below team level. The unit at below team strength is shown with a transmitter device of some kind. The disposition of enemy units is typically obtained from intelligence information and is updated from reports by reconnaissance units as soon as new intelligence becomes available. The unit at team strength is shown with a building or like structure. The commander can place a cursor over the structure and this brings up a menu, shown in FIG. 8, offering Target, Visual and Intelligence. The visual item brings up a photo or drawing of the structure if available from the intelligence. FIG. 8 shows a movement plan against the enemy units, which is now explained with reference to FIG. 9.

Reference is now made to FIG. 9 which is a simplified screen shot showing a contour map on which an operation is planned against the enemy units shown in FIG. 7. Three units, each indicated by separate arrows are given a starting position and starting time, 0620 hrs. The leftmost unit is sent over a minor peak and into a valley from which to make a frontal assault on the rearmost of the two enemy units. The middle unit is sent directly uphill to make a direct assault on the forward enemy unit. The rightmost unit is sent in a hook movement behind another peak to attack the enemy units from high ground to the right. Each unit is assigned a target time for arriving at their target location from which to launch the attack.

The movement arrows may be drawn directly on the commander's computer using any drawing facility known in the art.

Referring again to FIG. 8 it is noted that shading fills some of the arrows and misses other arrows. The shading indicates actual progress of the units. The rightmost unit has proceeded directly to his target. The leftmost unit, partially obscured by the image of the building, has deviated from the planned path, and the center unit has stopped short. The commander receives data in real time from the fire control devices on individual soldiers indicating their location, whether they have used their weapons and in which direction. The information is then displayed at the desired hierarchical level. The screen in FIG. 10 allows the commander interested in the operation shown in FIG. 9 to select the operation and he is shown the list of units involved, in this case Alpha 1 and Alpha 2.

Reference is now made to FIG. 11, which is a screen shot showing the same terrain map as in previous figures and shows how the commander can choose a time frame to follow the attack. At any current time he can look at the map and see the development of the situation over previous ten minutes, thirty minutes or hour, or simply look at the current update. Alternatively the commander can look at a replay of a particular time interval in the past, say the period of thirty minutes that began an hour before.

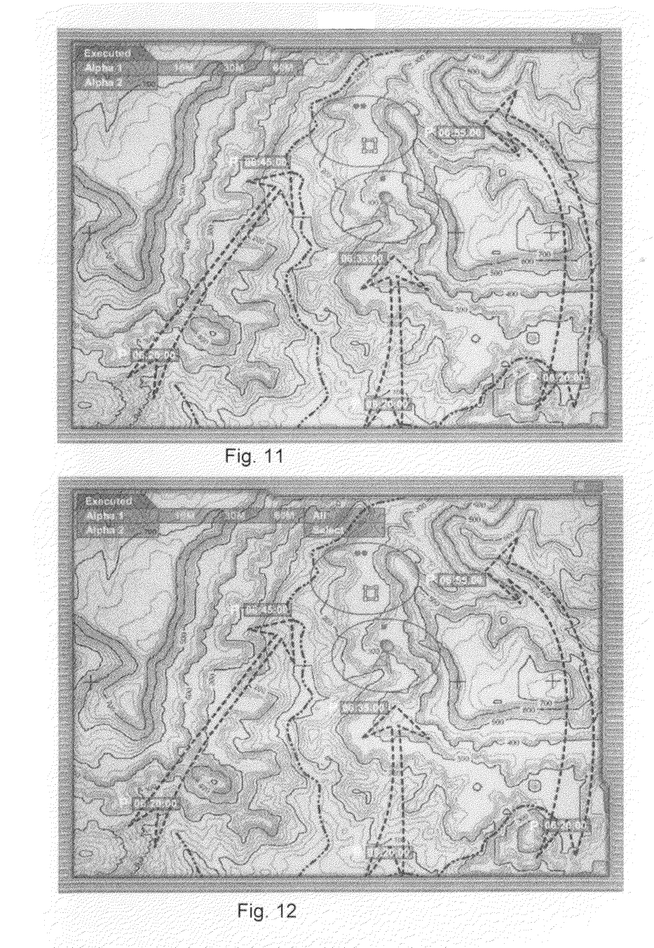

Reference is now made to FIG. 12, which is a simplified diagram illustrating the way in which the commander is able to select all units involved in the operation or just specified units. In this case the commander can choose between Alpha 1 alone, Alpha 2 alone and both units together. The screen illustrates the plan, including movement axis and time schedules so that the commander can see not just the location of the forces but whether in fact the current location is in compliance with the plan.

In select units the commander is able to choose only special units that interest him or specific soldiers, say commanders or medical officers or reconnaissance or communication units.

Reference is now made to FIG. 13, which is a simplified diagram illustrating the “all” selection chosen from the window of FIG. 12. In the screen of FIG. 13 are shown the individual soldiers involved in the operation, V1 . . . V10, who are all selected. An OK button allows for the screen to be selected and to move to the next screen illustrating real time operation.

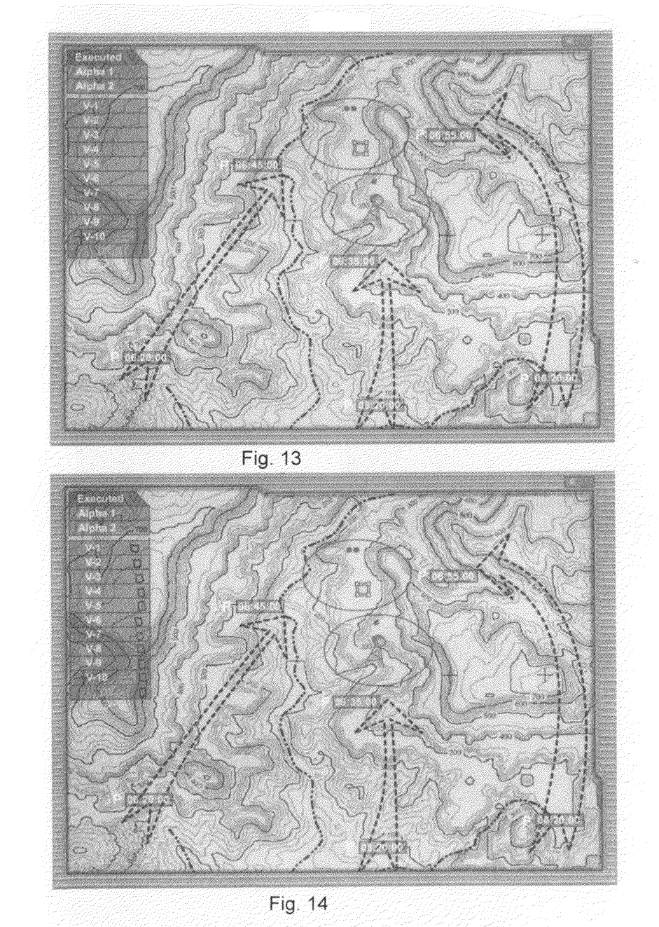

FIG. 14 is the same as FIG. 13 but allows for the use of a checkbox to select individual soldiers.

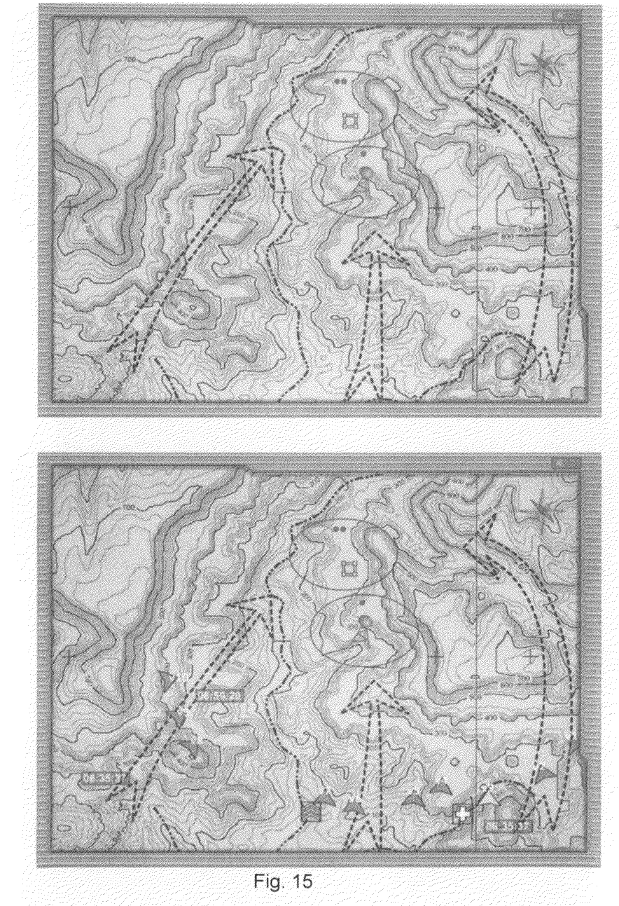

Reference is now made to FIG. 15 which is a simplified screen shot illustrating a real time location of soldiers shortly after the start of the operation. Each individual soldier is illustrated by an arrow indicating the direction in which he or his weapon is facing and a number V1 . . . V10 that identifies him individually. The commander and medical soldiers are indicated. It is clear that the leftmost group are making some progress but the center group and one of the rightmost group are still at the start line and in fact the center group's soldiers appear to have fanned out. The medical officer V3 appears to be in some difficulty as his color has lightened. Color coding can be used to indicate the status of a soldier. For example green may indicate functional or physical ability to complete the task. Yellow may indicate lack of supplies or injury, and red may indicate incapacitation, again physical or functional.

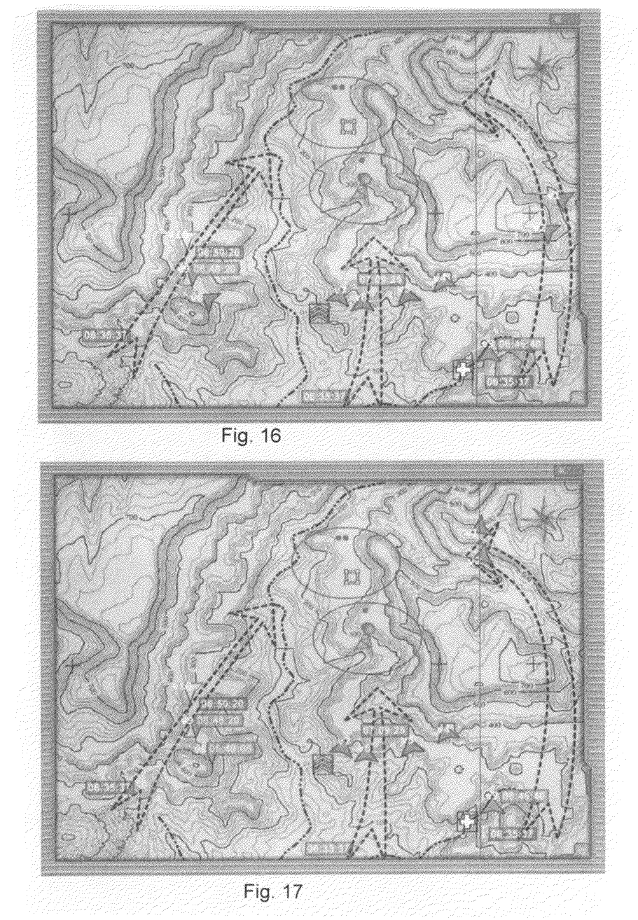

Reference is now made to FIG. 16, which is a simplified screen shot showing the situation a short time later and to FIG. 17-19 which show the situation at various intervals as the situation develops. The leftmost group managed to get to the valley but then turned to the left (apparently empty space) and started firing. Within the space of two minutes each of V8, V9 and V10 were put out of action. This gives an indication of the presence of a currently unknown enemy force to the left of the attacking forces.

At the same time, the rightmost group lost V3 close to the start of operations, continued firing on the enemy's forward position. The rightmost group arrived in position.

Only the rightmost group has in fact reached the target position.

The commander can therefore see at a glance exactly what has happened to his operation. Apparently the leftmost group was ambushed. The center group was spotted by the enemy towards the start, and had to modify its advance. The rightmost group reached its position and began firing but the enemy was not dislodged.

The commander thus has exact information about what has happened and is able to make a further decision based on exact knowledge of the situation. He knows exactly what forces are currently in position and where the casualties lie should he decide to reinforce or evacuate.

The information is available at a glance because actual movement, in color, can be compared directly with the plan, dotted, on the same screen and actual times appear against planned times. Different stages in an event can also be distinguished by different colors or patterns.

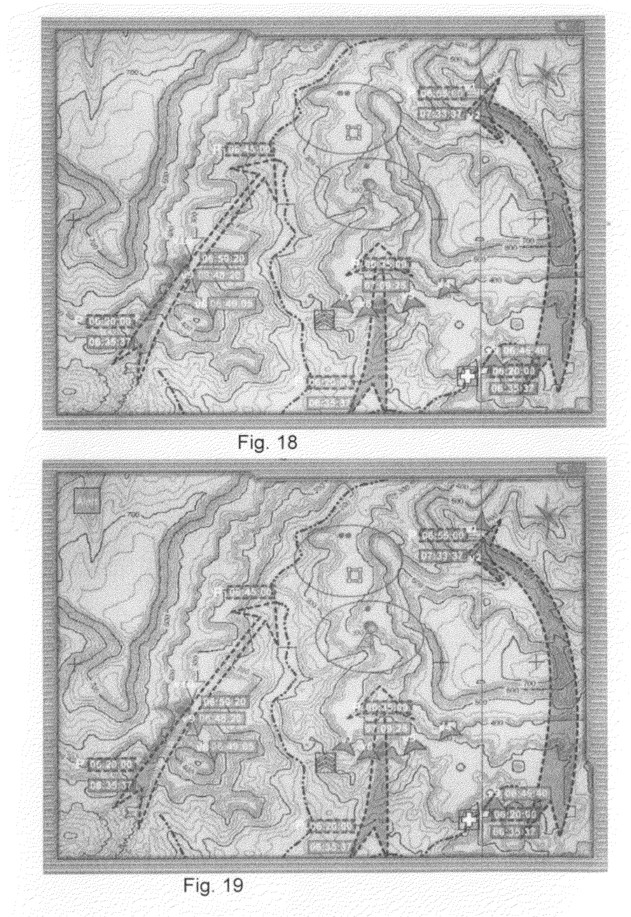

A particular plan may have several components that need to be carried out in sequence, or there may be several operations which need to be carried out in sequence. Use of the map of the present embodiments may show or even evaluate that one particular component has not been completed and therefore a future stage should be aborted. Thus in FIG. 18 the shadowing clearly does not follow the arrows and it is clear that not all stages of the operation have been completed as necessary. The information can be passed up or down the hierarchy and can give real time information as to whether further mission stages should be begun, continued with or aborted.

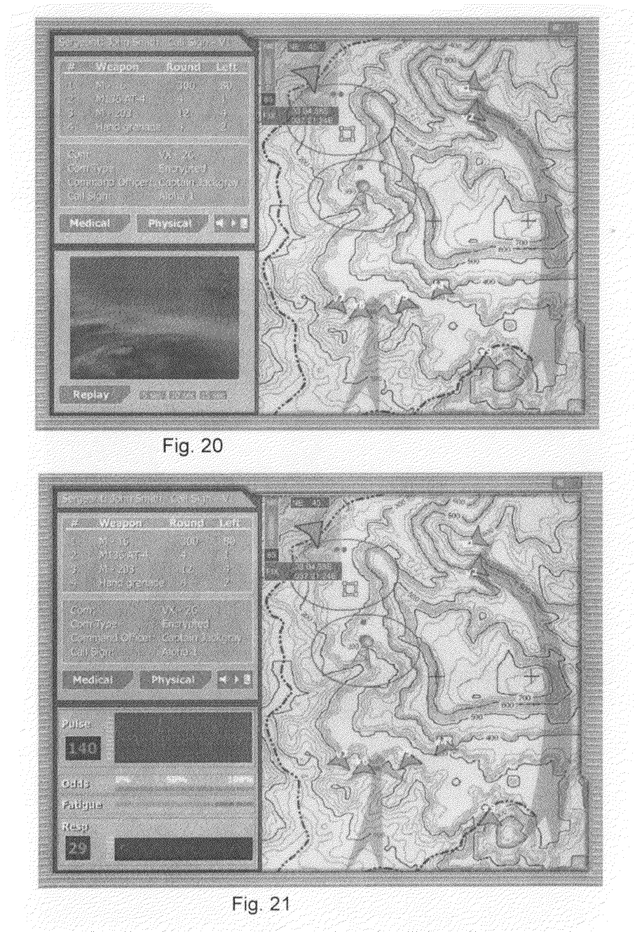

Referring now to FIG. 19, the amount of ammunition fired towards the unknown general vicinity of the enemy position is indicated. Furthermore GPS, azimuth, elevation angle and ballistic data are combined to provide an estimate of a strike zone, which can then be placed on the map. If a round is fired then the data for the firing can be stacked.

The officer can then view the information at various hierarchy levels. With reference to FIG. 20 onwards, number of casualties, amount of ammunition and/or presence of equipment, and/or keeping up with a predetermined timetable or combinations thereof can all be used to evaluate operations or components.

Likewise operations that require a high degree of coordination between forces, say a creeping barrage which requires coordination between an infantry and an artillery unit, can be managed in real time.

The information about the components of the operation can be calculated locally or at a central location and then alerts can be sent out in accordance with a predetermined hierarchy. The results can then be presented visually for example in accordance with a color scheme in which forces that are supposed to wait are shown in red and forces that are supposed to operate are shown in green. Forces that are facing problems may be colored yellow. Issues that are to be regarded as problems may be predetermined. The level of ammunition in a unit, the number of able-bodied soldiers, the number of wounded, compliance with a timetable etc, are all features that can be used to measure the fighting capability of a unit. Yellow indicates a unit needing special attention.

The situation of the individual units can also be shown. The color of the unit can indicate its battle-readiness. A three color system may be used with green indicating that the unit is complete, orange that the unit is damaged but still fit for carrying out the mission, and red indicating that the unit is now unable to complete its mission. Logic may be programmed to indicate the different levels of readiness and different logic may be suitable for different kinds of mission. The different colors may be applied to any level of unit, thus it may be applicable to individual soldiers, and to larger units. A unit of thirty soldiers may for example be indicated as red when only ten soldiers are left standing say in a general defensive operation but may show red when fifteen soldiers are left standing in a more complex offensive operation.

Reference is now made to FIG. 20 which is a window illustrating a display screen for an individual soldier. The officer is able to click on individual soldiers and find out a considerable amount of information about their real time situation. In this case the selected soldier is V1. He has a rank and a name and V1 is his call sign. His weapons are shown together with numbers of rounds issued and rounds remaining. His commanding officer and unit call sign are also shown. A choice of buttons is shown, physical and medical. Other buttons include sound buttons so that real time or recorded sounds surrounding the soldier can be heard.

Different icons may be used for different kinds of units or different sorts of soldier, or may present different types of information. A helicopter or armored unit may be indicated for example by specific icons.

Referring now to FIG. 21 and the medical tab is selected. A pulse or ECG or respiration readout is shown. In this case the pulse is high but that is to be expected in the middle of a battle. His odds of survival is a simplified estimate allowing a commander to allocate resources in the most effective way to provide medical help to injured soldiers. The fatigue level is high and respiration is shown.

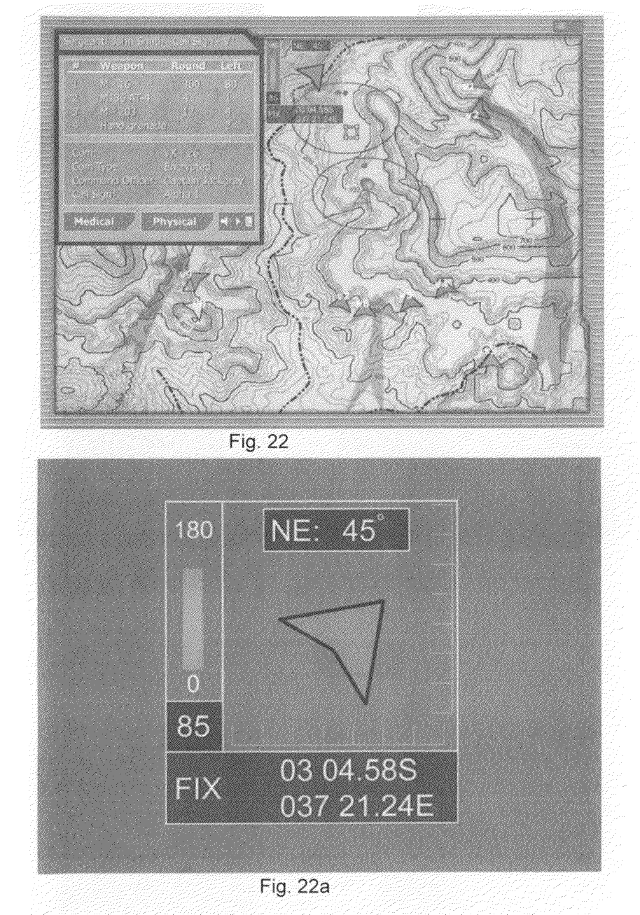

FIG. 22 illustrates the display shown from the physical tab. The direction of gunfire is shown as an arrow and the sidebar shows the elevation of the weapon. FIG. 22A shows the physical display enlarged. The GPS location is indicated below.

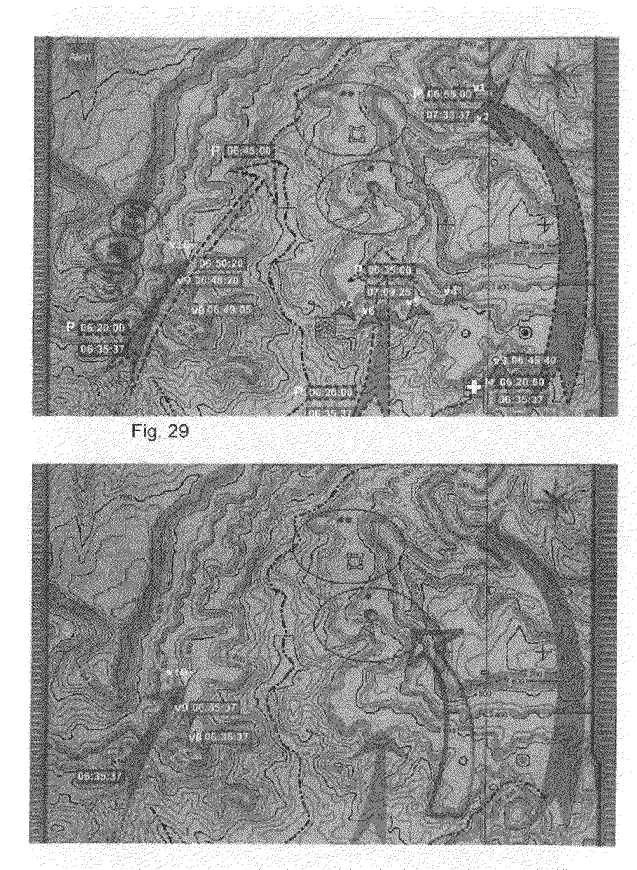

The weapon usage can be monitored and a ballistics chart can be used to estimate the approximate fall of the bullets based on the weapon used and the information shown in FIG. 22, and therefore the system can estimate regions of likely enemy displacement. These regions can then be displayed on the physical map and the number of bullets can be highlighted. Examples of such regions are shown in FIG. 29. The actual number of rounds fired can be shown, or the region can be colored in accordance with the approximate number of bullets fired. The system can also distinguish between who fired the bullets.

The system can know what ammunition is present by for example the location of a grenade in a touch-sensitive pouch. Alternatively an RFID or like device may be used. It will be appreciated that the RFID can be replaced by other devices that indicate presence or absence of items and/or identify the device. The RFID is of course destroyed upon detonation or ceases to be detected once distant from the soldier so that the system knows what ammunition is present or has been used. The system is also updated when the soldier receives new ammunition. As well as hand grenades the system can monitor missiles or ammunition for any other personal weaponry. In the case of a missile the RFID can be located so as to be destroyed as soon as the weapon is used.

Alternatively a voice-activated system can be used so that the soldier can be asked to list the number of grenades left, or the number of bullets left. Such questioning can be carried out as a preset routine or in response to external activation, and enables a remote third party to know the situation.

A rolling version of the sequence can be shown. The soldier or unit icon may be shown advancing and firing his weapon, or the different strike zones may be shown in sequence as the icon moves from one strike zone to another.

A sound tab allows the officer to listen to sounds around the soldier, either at the present time or at earlier predefined times.

The screen below shows details of the weapon in terms of the direction at which the weapon is pointing and the angle of tilt. The location is also shown.

The medical or physical situation of soldier V1 can be shown and replayed via a replay button. The replay button with a screen is shown in FIG. 20 above.

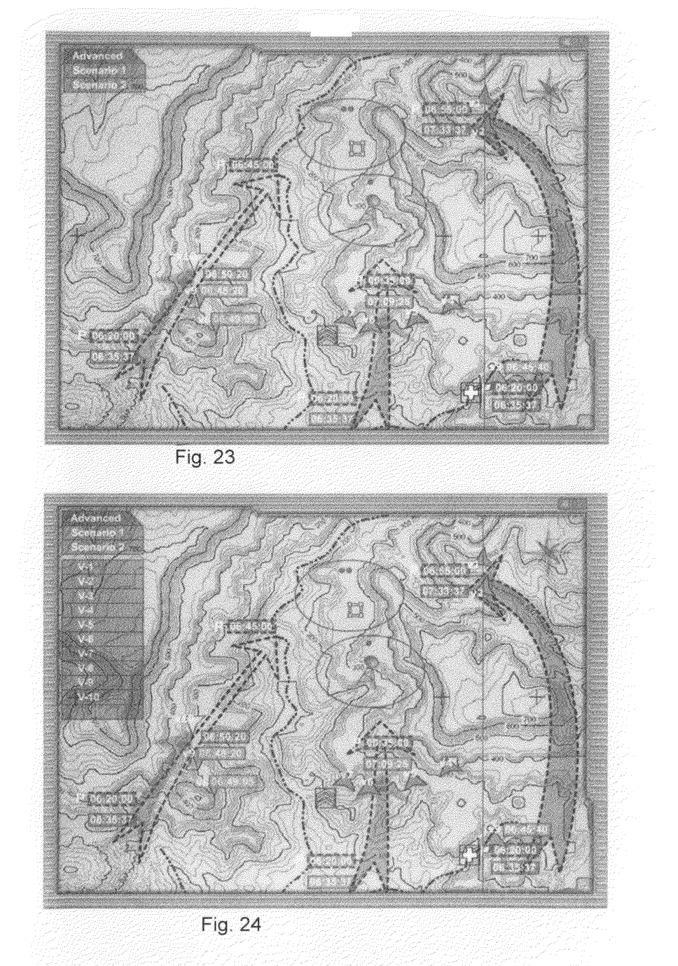

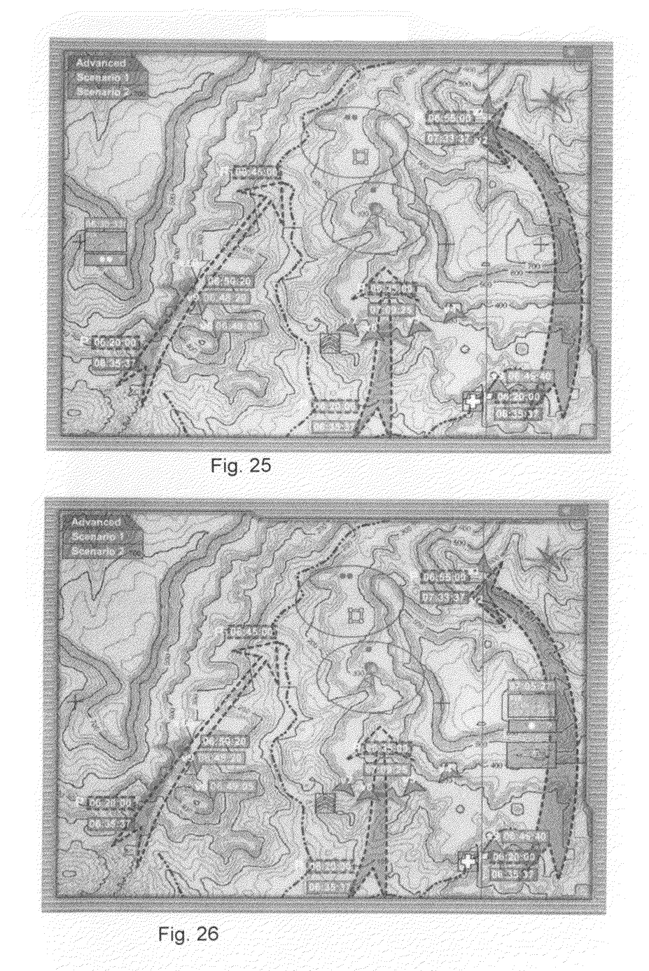

Reference is now made to FIGS. 23-28 which show the system in use in a training mode in which scenarios may be set. FIG. 23 allows the commander to choose between two scenarios that may be provided to a commander in the field. FIG. 24 shows the situation arrived at in the battle situation of the earlier example. In FIG. 25 an advanced screen allows for the surprise injection of the enemy forces that may have caused the apparent ambush shown in the left hand side of the screen. As seen the size of the force is given with two dots, indicating company size, but followed by a question mark, indicating that the intelligence source is not sure of his information.

A soldier upon spotting the enemy may do more than spot the enemy. He may also be able to enter an arrow indicating his view of the likely movement of the enemy force. He may also insert actual movement of the enemy. The arrows can be entered directly on the map using the touch screen or on a tablet PC.

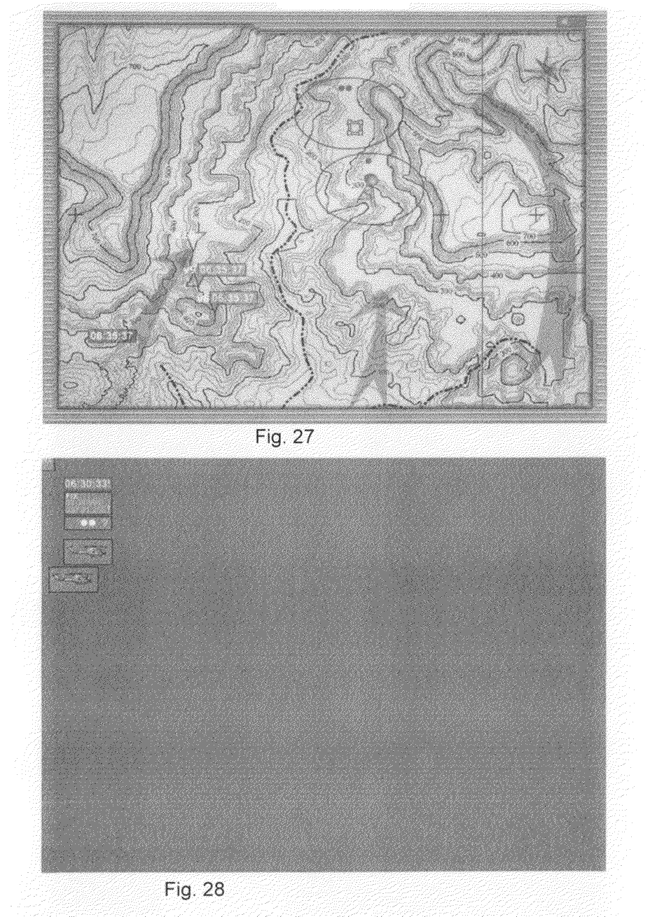

FIG. 26 illustrates the injection of a small enemy force including armor at a position that cuts off the rightmost forces from the main body. FIGS. 27 and 28 illustrate the appearance of an alert and the injection of an enemy force by helicopter. The injected information is associated with other forces located nearby so that the injected information is shown alongside the forces when they are selected in a zoom. The system therefore combines intelligence, logistics and terrain information on a single map in real time. The new information is preferably associated with the nearby units so that any check on a given unit will show the nearby enemy forces. The association is therefore ready and available for any new user, for example a new officer who comes onto the scene, and the individual unit can automatically be alerted to intelligence of nearby enemy forces.

The information can be injected in accordance with a predetermined set of rules and can be associated with the quality or relevance of the information. For example, in order to determine what has happened to some reinforcements sent recently by a given route, an air attack in the vicinity from three days ago is entirely irrelevant, however information of a mine field from thirty years ago may still be relevant. The user is also able to add or remove information as desired, so as to get the information he needs but not to suffer from information overload.

Information can be accessed according to one's level in the hierarchy, thus officers may be shown only their own forces or certain types of forces or forces that are involved in a particular mission. Certain users, such as commanding officers, may wish to see specifically medical units or military police units or the commando units spearheading a particular mission. The units may be indicated according to their adequacy for a given mission or for the current situation as understood. In other cases a high level view may show all kinds of forces involved in say a particular emergency. Such would be useful in coordinating the response between civilian emergency and military units in say a terror attack.

In injection mode, new information of enemy forces is placed on the map. The data may represent enemy forces, time, estimated location, size or strength, and special information such as kind of force. Quality of the information can be indicated by the information source as definite, (exclamation mark) or indefinite (question mark). A second soldier on site can validate the information as he sees the same forces by entering the data on his PDA.

In exercises the system can allow information to be injected into the system as an exercise to see how quickly the forces react, or deliberately false information can be added to the system to see how the forces react to and deal with the error.

The system can also be used to insert commands. The commands can be color coded according to the level from which they are issued and can be directed at any desired level of unit. The system is visual and designed to be seen on a portable screen.

The system may be based on a central computer that receives data from the individual weapon monitoring devices and from other sources and then sends the results to the individual users. Alternatively certain information can be sent to just one location.

Whilst the above has been described mainly in terms of monitoring of weapons of individual infantrymen, it will be appreciated that the same kind of monitoring and deployment control can be applied to other kinds of military units such as tanks where the device is mounted on the cannon. Alternatively the information generally available from a tank is processed in accordance with the principles set out hereinabove. That is to say the information available in any event from the tank's fire control system may be analyzed and included in the present system.

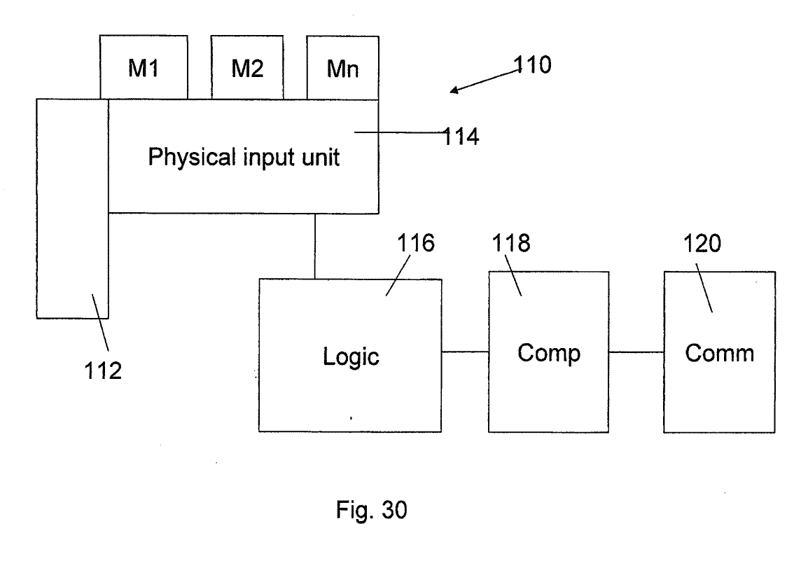

The case of a vehicle mounted system is now considered. Reference is now made to FIG. 30, which shows an emergency situation detection apparatus with a mounting for placement in a vehicle.

A vehicle emergency situation detection device 110 comprises:

a mounting 112 for mounting the device on a vehicle,

a physical input unit 114 for receiving vehicle motion data. The physical input unit has several measurement devices, M1, M2 . . . Mn.

A logic unit 116 is associated with the physical input 114 for translating detected motion into vehicle behavior, as will be described in greater detail below.

A comparator 118 compares the vehicle behavior with predefined dangerous behavior to indicate the occurrence of an emergency situation.

In an embodiment there is provided an alarm state manager to call for assistance, for example via automatic opening of a radio link via communication unit 120, or of a video link, to a central controller, thus to provide immediate indication of an emergency state. Preferably, the link, which is at least an audio link, includes at one end a speaker and or microphone located in the vehicle.

In a further preferred embodiment specifically for an aircraft cockpit, the alarm state manager is able to initiate an automatic download of the aircraft's flight recorder or black box data to a central controller, thus making available flight information even if the black box is never recovered.

The alarm state manager is preferably also able to enter an alarm state under the influence of other detectors, for example with detection of a loud noise or following prolonged instability. The alarm state manager may be able to enter different levels of alarm states prompting different actions.

In a further preferred embodiment of the present invention, the emergency situation detector includes an audio or other confirmation channel which can be opened upon detection of an emergency in order to provide confirmation of the situation or allow two-way communication, or the like.

In a further preferred embodiment the emergency situation detector 112 includes a GPS detector to provide positioning information.

A further preferred embodiment intended for a user who stays within a predefined area, such as a police car on patrol, simply sends regular code signals from which the system infers that he is in position.

Further preferred embodiments are provided to determine attitude, position and motion of the vehicle. Thus the emergency situation detector may include an accelerometer. The detector includes a compass needle and the relative alignment of the compass needle relative to a predefined forward direction of the body provides information as to the direction the vehicle is facing.

In a further preferred embodiment, emergency situation detectors are provided to two or more vehicles in a team. The signals from different members of the team can be compared to determine who is the closest to an event. For example the intensity of an audio signal as received from two different users can be compared to determine who was the closest to an explosion. The team can then be instructed accordingly to deal with the situation.

As an alternative, the physical signal can be compared with a detector of the surroundings, for example a detector located on the wall of the aircraft. Thus vibrations due to the aircraft can be discounted.

In one embodiment, data is stored for a predetermined time in a stack, for example a FIFO stack. The size of the stack may be a given amount of data, or may be a given amount of time, or some other factor as preferred. In the event of the detection of an emergency situation, all of the data currently in the stack is saved, so as to allow subsequent analysis. The stack embodiment is useful because it makes available information from directly before the emergency, often extremely useful in any investigation.

Embodiments of the present invention may use a private communication channel. In one embodiment the equipment located on the user has a short range radio transmitter receiver and a corresponding transmitter receiver is located on a vehicle telephone arrangement (carphone). The device at the telephone socket includes an automatic dialer which makes a connection with the controller. For greater range the device at the user may transmit to a repeater which then transmits over a greater range. One embodiment of the repeater may be located at a convenient nearby power socket, say the vehicle cigarette lighter. Other embodiments may make use of existing channels such as the cellular network. Yet other embodiments may comprise universal communicators which make use of public networks if detected and use their own channel of communication otherwise.

According to a further embodiment a system comprises rule based logic. The subject vehicle is expected to follow certain rules, for example a police patrol car patrols within a certain area. If the vehicle were to begin speeding, or move outside the area it would be apparent that an abnormal situation may have arisen. Should the vehicle suddenly decelerate and then cease to move at all then something is wrong. Should the vehicle suddenly accelerate upwards and then fall down, followed by ceasing to move then it would be apparent that the vehicle has struck a mine. Thus the sensor is usable in combination with the rule based logic to detect non-compliance with the behavioral rules, to indicate an abnormal situation and if necessary to set off an alarm or otherwise summon help. It will be clear that the more independent sensors are used the more reliable the determination can be.

The system may be set to await an additional indication such as an impact or the sound of an explosion, or signs of rolling or the like or an indication of an impact, which may indicate that the vehicle is under attack. The detection comprises features, upward acceleration, sideways acceleration, downward deceleration, and the features may be combined into words. Thus a sudden sharp deceleration at high G combined with the vehicle coming to a stop can be combined into a word, that is an indication of a crash due to a frontal collision.

In a preferred embodiment, the detectors are programmable. The rules can be changed for different users or for allowing the same device to given to different vehicles having different requirements. Thus aircraft and ships would have different expected behavior and indicators of danger than land vehicles, and land vehicles may differ between military and civilian vehicles. A civilian vehicle may usefully be programmed to detect an apparently drunk or asleep driver.

The device can also be dynamically programmable according to parameters it is able to detect. Thus it may be able to use detected locations to change between different sets of rules. In an example the change of rules may be carried out on line, for example over a radio connection.

A position or location detector may be used in combination with the above system and the rules preferably define location based behaviors. The cellular system can provide location information.

The behaviors that may be defined include a crash, an under-vehicle explosion, a side-of vehicle explosion, a behind-vehicle explosion, an above-vehicle explosion, and a driver losing control. In addition features such as the sound of the explosion could be detected to be taken as confirmation. If there is a sound detector then it is also possible to detect the sound of breaking glass. Breaking glass can also be an indicator of someone attempting to break into the vehicle when not in use. A flash fire may be detected or a shock wave or smoke or other indications of an explosion or fire.

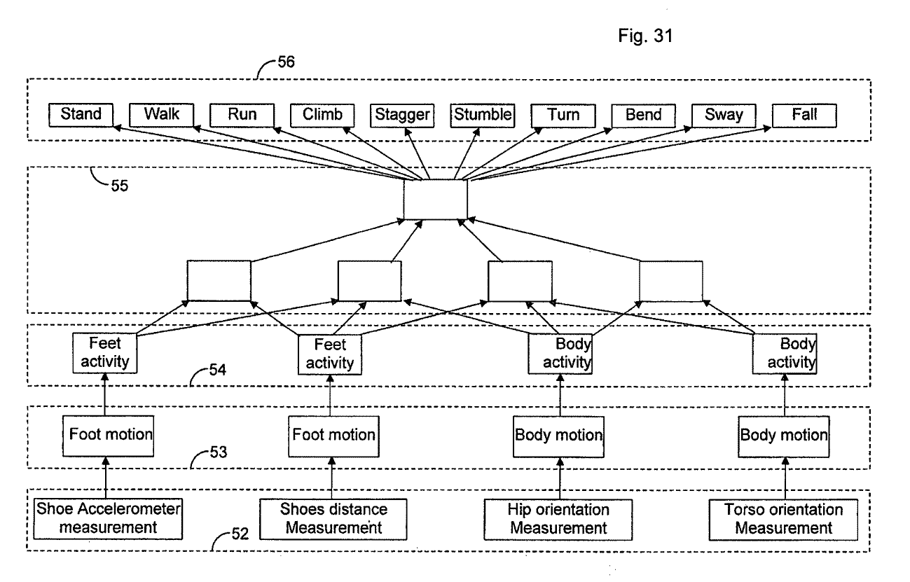

Reference is now made to FIG. 31, which is a simplified illustration of a preferred embodiment of the present invention, showing a structure of terms describing activities and explaining how words and phrases are built up.

At the bottom line of FIG. 31 there are first-level or direct measurements 1 of activities or of a proximal environment's parameter measurements, preferably received from respective measuring devices.

The measurements may include but are not limited to: acceleration, speed, direction, electromagnetic signals, inclination, the distance from a solid surface, and an impact's pressure.

The measurement may further include measurement of environmental parameters such as smell, sound, or air pressure that are taken in proximity of the monitored vehicle.

Preferably, these first-level measurements 1 are integrated, differentiated or otherwise calculated to provide second-level measurements 2.

The first and second level measurements of activities are then preferably processed to provide third-level measurements 3.

A single measurement of an impact may indicate an accident whereas a sequence of such impacts may indicate a continued attack on a military vehicle.

Acceleration beyond a certain threshold, together with impact-type sounds or a measured impact on the body, can be interpreted as a shock, for example as a result of being hit.

Sounds can also be analyzed for meaning, and then understood with or without context.

For example the driver may call out “help”. Utilizing current speech recognition techniques, the help call should automatically set up an alarm state. Driver physiological states could also be monitored and then if the term is accompanied by a significant change in heart rate or respiratory rate then it is clear that something has happened.

A system according to preferred embodiment of the present invention may be configured to set up an alarm state upon recognizing a predefined code word spoken by the driver, such that the driver may use a secret code word to signal he is under attack. For example, a hijacked passenger aircraft's pilot may use a code word that would not make the hijackers suspicious to report the hijacking to the air traffic control.

Preferably, a system according to preferred embodiment of the present invention may be further configured to analyze the context and tone of the spoken code word thus taking into consideration the emotional setting of the spoken code word as well as the circumstances when the word is spoken. The same word may be spoken calmly, spoken together with an increase in heart rate or together with falling on the floor, and thus in some cases may be an indication of alarm, and in other cases may indicate nothing at all. Thus the word “help” may be stated in the context of a joke, signifying nothing, or in a sharply rising pitch or accompanied by the monitored subject's physiological or physical parameters indicate stress.

Similarly, orientation angles of the vehicle or driver can be continuously measured and when the angle surpasses at least one of predefined thresholds, or when the rate of change of the angle surpasses at least one of predefined thresholds, a third level deduction of falling may be the result.

Combinations of specific lower level measurements are also preferably processed to provide forth level indications 4. Fourth level indications combine the third level indications to understand behavior, thus loss of control by a driver may be understood from different combinations of previous level measurements.

Typically at least some of the second, third and fourth levels of measurements of body activities preferably involve time measurements that are acquired from a clock, or from timers calculating elapsed time between specific measurements, or lack of such.

Fourth, third, second and first level measurements and activities, as well as time measurements, are then preferably combined, sequenced, processed and compared at an even higher level to determine one of a fifth level of activities 5, which is the assumed bodily condition or activity of the vehicle.

The Fourth, third and second body activities typically and preferably form the phrases 116 of FIGS. 30 and 31 while the fifth level of the activities typically and preferably form the sentences referred to above.

That is to say, individual primary measurements are formed in the second level to form words that describe activity. At the third level these words combine to form phrases and at the fourth and fifth level, super-phrases or sentences are generated.

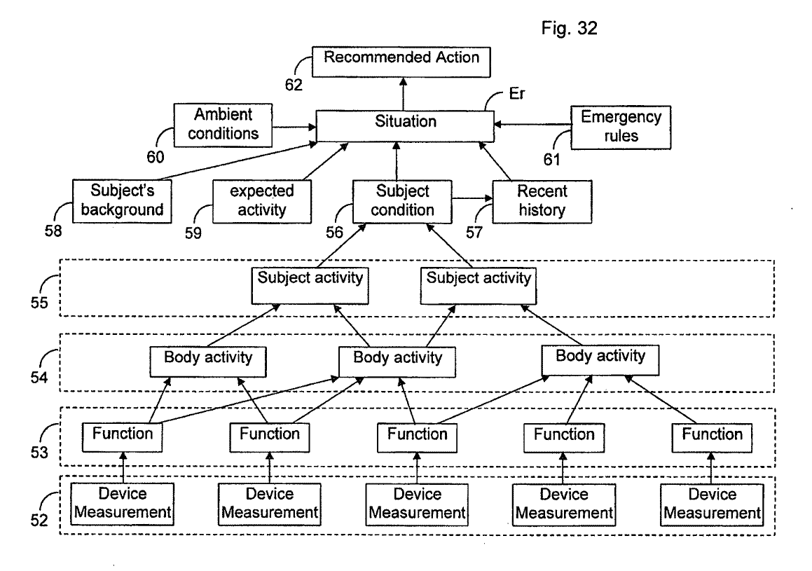

Reference is now made to FIG. 32, which is a simplified illustration of a preferred embodiment of a processing system for interpreting raw measurements.

The structure of processing steps preferably comprises the processing of the first level 1, second level 2, third level 3, fourth level 4 and fifth level 5 of activities described above. The activity of the highest level, preferably level five in this example, is then added to a recent history 6 of events occurring, the vehicle's expected activity 7 and the ambient condition 8 to determine, according to a pool of rules 9 how the situation is to be understood. A recommended reaction is made to the driver, or an action 10 is then provided to an attendant or emergency crew or any other person who is in charge, or responsible.

The rule base 9 is a collection of assumptions of situations that pertain to the activity of the vehicle, whether regular activities, abnormalities or emergencies.

Such assumptions may depend on the subject's condition, environment, situation, etc.

The rules are expressed using a terms or labels built into a language comprising the structure of human and body activities terms as described above. For example, emergency situations can be expressed as:

impact and Move and impact=alarm

STOP and LAUGHTER=ignore

impact and AT LEAST 10 seconds and fall to more than 55 degrees and stop and over 2 minutes=alarm

The above two cases make the point that relatively subtle differences in the order of events can give rise to completely different outcomes. Such differences are very clear to humans but have up till now caused difficulty for digital systems.

The use of the present embodiments thus provides machine processing with a natural basis on which to understand these subtleties. These variations allow for suitable programming to be used for different policemen in different circumstances or operations.

Preferably there may be many such rules that apply to a specific subject. The computer continuously processes the recent events to check for a possible match to at least one rule. It is also possible that more than one rule is fulfilled at a certain point of time. It is further possible that a short time after one rule is fulfilled another rule is also fulfilled. In certain cases such situation may lead to an alleviated state of emergency, while in other situations the state of the emergency may be demoted.

It is appreciated that the analysis of several combinations of measurements and sequences of measurements can lead to different conclusions. The computer is operative to resolve such situations and determine a prevailing situation based on statistics, fuzzy logic, and other adequate mathematical methods.

Combinations and sequences of activities are then observed to determine a state of emergency and suggest an appropriate response. If the situation requires so, an alert is provided to the attendant or directly to a rescue team.

Preferably, the raw measurements are not transmitted but rather only the conclusions associated with the second, third, fourth and fifth activities are provided by the transmitter to reduce the amount of transmissions, save bandwidth and save battery power.

The computer is preferably operative to retrieve the stored measurements and display them, preferably in the order in which they occur, preferably at any required level of activity.

In one preferred embodiment, the computer is preferably operative to use the words, phrases, and sentences to animate the activity of a vehicle, simulating the subject's behavior and motions, preferably at the rate in which they occur, alternatively and preferably at a faster rate.

The computer receives the words, phrases, or sentences from the subject and applies them to a virtual subject on screen which then carries out the activities indicated by the words, phrases, and sentences.

Preferably, if a three dimensional model of the environment is available, the computer is able to display the location, activity and status of the vehicle within the environment.

The system need not be specific to vehicles. The following is a vocabulary for a system that is suitable both for vehicles and for personnel.

The system enables a user to define structured terminology of human activities, based on interpretations of body activities that are based on interpretations of physiological measurements. Such terminology may be

Example of Basic Physical Measurements:

LEVEL 1
1. Measure body's recline and limbs orientation in three dimensions angles.
2. Measure driver's voice loudness.

LEVEL 2
3. Calculate change of recline and orientation as a function of time.
4. Calculate angles as directional acceleration and velocity.
5. Compare values with predefined thresholds, determine MOTION, IMPACT, SCREAMING etc.

LEVEL 3
6. Integrate with other measurements such as the motion of driver limbs, speech, noise level, etc.
7. Determine RECLINE, TURN, TILT, SWAY, etc.

LEVEL 4
8. Analyze the probable cause for the motion, such as intentional or external.
9. Analyze in the context of previous measurements and analysis.
10. Determine driver, SIT, LAY-DOWN, INTENTIONAL-FALL, UN INTENTIONAL-FALL, KNOCKED-DOWN, WALK, IMPACT FROM BEHIND, IMPACT FROM THE LEFT, IMPACT FROM THE RIGHT, IMPACT FROM IN FRONT etc.

LEVEL 5
11. Analyze with respect to the precondition of the monitored subject and the situation, determine emergency situation or any other predetermined abnormality.
12. Measurements of motion and their logical assumptions,
1. Motion
2. Step count
3. Directional impact as value, e.g. impact of 2 g
4. Directional impact by logical pattern, e.g. impact relative to object.
5. Impact in logical context, e.g. police vehicle patrolling a hostile neighborhood.
6. Impact by relative context, e.g. an impact of 4 g means collision or explosion.
7. High g impact from below means a mine. GPS or other location system gives absolute positioning
1. Location as value, e.g. is the subject where the subject is supposed to be?
2. Location by logical pattern, e.g. following an expected path.
3. location in logical context, how long is the subject in given position at given time.
8. Location by relative context, where is the driver relative to vehicle?
1. Relative positioning, the location of the subject relative to the location of his equipment.
1. Location as a directional value, e.g. 30 degrees south of the vehicle.
2. Directional by logical pattern,.
3. Direction in logical context, e.g. two crew members going separate ways.
4. Direction by relative context, e.g. two crew members leaving the vehicle together at a run.

Time:

Time is connected to all other events. Each event receives a different value according to the duration of the event and the timing with respect to other events.
1. Absolute time, needed to decide that something is what should be happening at this time. He is supposed to move at 11 AM
2. Relative time, measure time that the vehicle travels, speeding for a few seconds is OK, but if speeding is extensive perhaps the subject is pursuing or escaping from something.
3. Sequence of events in time frame.

Body or Physiological Events—Say of Driver of Crew Members.

Pulse, breathing, sweat, change in physical attributes,
1. Absolute value, e.g. heart bit rate=70→Normal
2. Relative value, change, e.g. heart bit rate increased by 20%→Normal CHANGE OF POSTURE
3. As a part of logical pattern, e.g. RISING
4. logical context, e.g. RISING FROM HIS SEAT
5. relative context, e.g. CAR DOOR OPENED

Physical attributes

Is the subject running, jumping, sleeping, sitting, etc.

Impact assessment derived from measurements of acceleration, which can be measured as linear acceleration and as angular acceleration.
1. Impact value
2. Absolute value, unrelated and unassociated (yet)
3. Directional: comes from behind, comes from in front, comes from right, comes from left, comes from above, comes from below
4. Relative, assumed object or person as a cause for the impact
5. As part of logical pattern, e.g. a sequence of impacts
6. In its logical context, e.g. stagger, fall
7. its relative context, e.g. police vehicle in a riot.

Typical Expressions Using the Aforementioned Language and Terminology:

curve and straighten and impact and CONTINUE=ignore

impact and curve and straighten and impact=alarm

In all of the above situations, the system can look for a predefined situation that it is necessary to monitor. In the same way it is possible to define a region about the predefined situation, about which predefined reactions may also be provided, but using thresholds which vary according to proximity to the predefined situations.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Deployment control system comprising:
a weapon usage monitoring system for obtaining data of weapon usage,
an aggregation system for aggregating usage of individual weapons to at least one predetermined level, and
a presentation system for presentation of said weapon usage individually or at said predetermined level.

2. The deployment system of claim 1, wherein said presentation system comprises at least one token for presentation of said weapon usage.

3. The deployment system of claim 2, wherein said token indicates a direction of fire.

4. The deployment system of claim 3, wherein said token indicates an elevation of said weapon.

5. The deployment system of claim 1, further configured to calculate ballistics information.

6. The deployment control system of claim 1, further associated with a memory stack for storing a predetermined amount of immediately preceding data, said detector being configured to save all data in said stack upon entry into a transmission mode.

7. The deployment system of claim 4, wherein said token is associated with firing detection and a ballistics calculation to indicate a target area.

8. The deployment system of claim 2, wherein said token indicates whether a weapon has been fired.

9. The deployment system of claim 3, wherein said token is associated with a second token indicating an elevation of said weapon.

10. The deployment system of claim 1, wherein said presentation system is further configured to present at least one of an ammunition level, a location, and a GPS based location of a weapon being monitored.

11. The deployment system of claim 1, wherein said aggregation system is configured to aggregate said weapon usage to a plurality of unit levels.

12. The deployment system of claim 11, wherein said unit levels are accessible according to a predetermined unit hierarchy.

13. The deployment system of claim 12, wherein said unit hierarchy is an operation-oriented hierarchy.

14. The deployment system of claim 12, wherein said unit hierarchy is the military hierarchy.

15. The deployment system of claim 1, wherein said presentation is configured to allow selection of a unit at a first one of said predetermined levels to lead to other units at hierarchically lower levels.

16. The deployment system of claim 2, wherein said tokens comprise different symbols to differentiate different unit types.

17. The deployment system of claim 1, wherein said presentation system further comprises a map.

18. The deployment system of claim 1, wherein said map comprises features and wherein at least some features of said map are represented by embedded images.

19. The deployment system of claim 1, further comprising an intelligence input system for allowing users to input real time intelligence information.

20. The deployment system of claim 19, wherein said intelligence input system comprises a distinction setter for allowing a user to distinguish between different quality levels of intelligence information.

21. The deployment system of claim 1, configured such that behavior of a unit or an individual soldier is gathered as intelligence information.

22. The deployment system of claim 17, comprising an input for allowing a current enemy position to be entered onto said map.

23. The deployment system of claim 1, wherein GPS, azimuth, elevation angle and ballistic data are combined on a map.

24. The deployment system of claim 23, further comprising functionality to use said combined data to calculate an estimated strike zone and place on said map.

25. Vehicle situation detection device comprising:
a mounting for mounting the device on a vehicle,
a physical input unit for receiving vehicle motion data,
a logic unit associated with said physical input for translating detected motion into vehicle behavior,
a comparator for comparing said vehicle behavior with predefined behavior to indicate the occurrence of a situation of interest.

26. Vehicle situation detection device according to claim 25, wherein said dangerous behavior is thresholded.

27. Vehicle situation detection device according to claim 25, wherein said physical input unit comprises an inclination detector.

28. Vehicle situation detection apparatus according to claim 25, wherein said physical input unit comprises an accelerometer.

29. Vehicle situation detection apparatus according to claim 25, wherein said input unit is additionally responsive to transmitter units.

30. Vehicle situation detection device according to claim 25, wherein said alarm state comprises automatic opening of a communication channel to a central controller.

31. Vehicle situation detection device according to claim 25, wherein said alarm state comprises automatic opening of an audio channel to a central controller.

32. Vehicle situation detection device according to claim 31, wherein an end of said audio channel is located in said vehicle.

33. Vehicle situation detection device according to claim 25, wherein said alarm state comprises automatic opening of a video link to a central controller.

34. Vehicle situation detection device according to claim 25, said alarm state being additionally triggerable by at least one of an instability monitor, a flash fire monitor, smoke detector, explosion detector, and a loud sound monitor.

35. Vehicle situation detection device according to claim 25, sized and configured for mounting unobtrusively on a vehicle.

36. Vehicle situation detection device according to claim 25, further comprising location detection functionality for determining a location, said apparatus further being configured to report said location.

37. Vehicle situation detection device according to claim 36, wherein said location detection functionality is one of a group comprising a GPS detector and a triangulation system.

38. Vehicle situation detection device according to claim 25, further comprising a direction sensor, said direction sensor comprising a compass and functionality for measuring an angle in relation to a reference.

39. Vehicle situation detection device according to claim 25, associated with a memory stack for storing a predetermined amount of immediately preceding data, said detector being configured to save all data in said stack upon entry into said alarm state.

40. Vehicle situation detection device according to claim 25, wherein said predefined dangerous behavior comprises at least one of the group comprising: a crash, an under-vehicle explosion, a side-of vehicle explosion, a behind-vehicle explosion, an above-vehicle explosion, and a driver losing control.
